(19) United States
(12) Patent Application Publication
(10) Pub. No.: US 2011/0027436 A1
(43) Pub. Date: Feb. 3, 2011

(54) USE OF THIOESTER FLAVORS TO IMPROVE THE FLAVOR QUALITY OF READY-TO-DRINK COFFEE UPON RETORTING AND STORAGE

(75) Inventors: Tuong Huynh-Ba, Pully (CH); Yu Chu Zhang, Norwalk, CT (US); Carol Borland, Richwood, OH (US); Catherine Gretsch, Prilly (CH); Imre Blank, Savigny (CH); Charles Andrew Knight, Ostrander, OH (US)

Correspondence Address: K&L Gates LLP, P.O. Box 1135, CHICAGO, IL, 60690, US

(73) Assignee: NESTEC S.A., Vevey (CH)

(21) Appl. No.: 12/742,008

(22) PCT Filed: Oct. 15, 2008
(86) PCT No.: PCT/EP08/63887

§ 371 Date: Jul. 29, 2010

Related U.S. Application Data
(60) Provisional application No. 60/987,471, filed on Nov. 13, 2007.

(51) Int. Cl. A23F 5/46; A23F 5/00

(52) U.S. Cl. 426/330.3; 426/534

(57) ABSTRACT

The invention relates to a thermally processed ready to drink liquid coffee product having an improved flavor quality after thermal processing and storage due to the incorporation of a thioester flavor precursor at a concentration of 0.005 to 7 mg/kg. Preferably, the flavor precursor is furfurylthioacetate, methylthioacetate or prenylthioacetate or combinations thereof and not limited to the above. The invention also relates to a process for preparing the improved flavor quality of a thermally processed coffee product.

### FIELD OF THE INVENTION

The present invention relates to the field of ready-to-drink (RTD) coffee. In particular, the present invention relates to the addition of thioesters such as methyl, ethyl, prenyl, or furfurylthioacetates or blends thereof as flavor precursors to RTD coffee and optimizing thermal processing conditions to initiate a chemical reaction converting the thioacetate into a thiol form at a targeted rate in order to impart enhanced flavor qualities during consumption after thermal processing and storage.

### BACKGROUND OF THE INVENTION

For preparing an RTD coffee, typically coffee extract powder or liquid coffee extract is dissolved in water, into which coffee aroma is added together with optional additives such as bicarbonate and sugar. Then, the resulting solution is thermally processed. The level of volatile coffee aroma compounds, in particular sulfur and nitrogen compounds, decreases and the coffee acidity increases upon thermal processing as well as during storage, thus negatively affecting the flavor quality of RTD.

Methylthiol and furfurylthiol are key aroma compounds in coffee imparting the roasted and coffee flavor attribute (O. G. Vitzthum, P. Werkhoff. Measurable changes of roasted coffee aroma in oxygen-permeable bag packs. Chemie, Mikrobiologie, Technologie der Lebensmittel, 1979, 6(1), 25-30.). The flavor precursors, methyl and furfurylthioacetate, which generate methylthiol and furfurylthiol, respectively, through hydrolysis, are chemically more stable towards oxidation in comparison to the corresponding thiols. Methyl and furfurylthioacetate have been identified in coffee (I. Flament, Coffee Flavor Chemistry, John Wiley & Sons, LTD., 2002). U.S. Pat. No. 3,702,253 discloses examples of adding flavor agents such as furfurylthioacetate alone or in combination with other sulfur flavor compounds to soluble coffee to modify the flavor of soluble coffee. These flavor agents can be added at a convenient step in the soluble coffee process such as plating the dried soluble coffee solids with a desired dilution of the flavor agent in an acceptable solution followed with drying. The flavor agents in solid or liquid form may also be added directly to a concentrated coffee extract and the mixture dried into a soluble coffee product which contains the flavor agent as an integral part thereof. The flavor agents may be incorporated into a dry powder beverage with or without whitener.

Thiol compounds such as furfurylthiol (FFT) have a much better flavor and aroma contribution than thioacetate compounds. However, thiol compounds degrade rapidly and readily, leaving the RTD product with little remaining aroma/flavor benefit. In contrast, thioacetate compounds such as furfurylthioacetate (FFT-Ac) are more durable than thiols, but do not provide the same degree of flavor and aroma benefit as the more easily-degraded thiol compound.

Typically, flavor agents are added late in the manufacturing process, as it is known that additional processing steps such as retorting can cause flavor loss and an increase in acidity, and these contribute to a reduction of flavor quality, particularly upon extended storage of the product. Although somewhat successful attempts have been made to alleviate the effect of thermal processing on flavor loss and acidity increase, the problem of flavor quality degradation upon storage still remains to be solved. The present invention now resolves these problems.

### SUMMARY OF THE INVENTION

The present invention overcomes the problems of the prior art by defining a method to maintain a constant supply of the rapidly-degraded thiol compounds. With this method, it is now possible to produce a thermally processed RTD coffee beverage having enhanced flavor and aroma features which last for at least 4 months at ambient temperature.

In particular, the present invention satisfies the need of the industry by adding thioesters such as thioacetates as flavor precursors to a coffee product prior to the thermal process and optimizing the thermal processing conditions to initiate a continuous chemical reaction that converts the thioesters or thioacetates into thiols. For example, the conversion of thioacetates into thiols takes place at a rate equal to the degradation rate of the thiol, thus ensuring that the beverage contains a sufficient amount of thiol compound to maintain a balanced flavor and aroma for a prolonged period. By adjusting the thermal process conditions, the rate at which the thioacetates are converted into thiols can be optimized in order to ensure that the beverage contains sufficient thiol quantities that the flavor and aroma remain balanced for a prolonged period. In one embodiment, FFT-Ac and methylthioacetate (MT-Ac) are converted to FFT and methylthiol, respectively, at a rate to compensate for the loss of methylthiol (MT) and FFT during thermal processing and storage, thus transforming the resultant RTD coffee from a more “soluble coffee”-like taste to a more “freshly brewed”-like coffee taste during consumption. In another embodiment, prenylthioacetate was incorporated.

The invention also relates to a thermally processed and stored ready-to-drink liquid coffee product comprising a coffee extract, a stabilizer, a buffer, water and a thioester flavor precursor in an amount sufficient to provide improved flavor quality to the product after thermal processing and storage of the liquid product for more than 4 months at ambient temperature and for more than 1 month at 60° C. storage.

The invention also relates to a method for preparing a ready-to-drink liquid coffee product having improved flavor quality comprising adding a thioester flavor precursor to the liquid product and thermally processing the resulting product. Advantageously, the thioester flavor precursor is added in an amount sufficient to provide improved flavor quality to the product after thermally processing and storage of the liquid product for more than 4 months at ambient temperature and for more than 1 month at 60° C. storage.

The liquid product to be thermally processed is typically filled into cans having a nitrogen gas containing headspace. Advantageously, the flavor precursor is added as a solution of 1-10% in ethanol.

In these products and methods, the thioester flavor precursor is preferably furfurylthioacetate, methylthioacetate, prenylthioacetate or a mixture thereof, and is present at between about 0.005 to 7 mg/kg, preferably between about 0.1 to 5 mg/kg. The product may also include at least one sweetener or at least one whitener for coloring and flavoring of the beverage.

### BRIEF DESCRIPTION OF THE DRAWINGS

FIGS. 1A-D show the degradation of furfurylthioacetate at 38° C. (curves A and B) or 60° C. (curves C and D) in black RTD coffee.

FIGS. 1E-H show the degradation of furfurylthioacetate at 38° C. (curves E and F) or 60° C. (curves G and H) in milk RTD coffee.

### DETAILED DESCRIPTION OF THE PREFERRED EMBODIMENTS

Generally, RTD coffee has less flavor and aroma than fresh coffee because aroma and flavor components are degraded during processing steps such as thermal processing and storage. It is now found that adding thioester flavor precursors such as methyl or furfurylthioacetates to RTD coffee before thermal processing improves the flavor and aroma and preserves those properties during storage, resulting in a fresher, cleaner, and more roasty and caramelized, but less bitter and ashy RTD coffee. This is a surprising result because these flavor precursors are expected to be degraded during thermal processing and storage. It has also been found that the level of the flavor precursor remains elevated during long storage. Furthermore, the level of the flavor molecule, either methylthiol or furfurylthiol, is also increased compared to control samples, as a result of precursor hydrolysis initiated by the acidity of RTD coffee. Due to the elevated level of the flavor precursors, the improved flavor and aroma effect is still perceived during consumption after more than 4 months at ambient temperature and for more than 1 month at 60° C. storage

Accordingly, the present invention improves the flavor quality of a thermally processed coffee product by adding a thioester flavor precursor, preferably furfurylthioacetate, methylthioacetate, prenylthioacetate or a mixture thereof, present in an amount sufficient to provide improved flavor quality to the product for more than 4 months at ambient temperature and for more than 1 month at 60° C. storage.

In one embodiment of the present invention, the concentration of the flavor precursor in the coffee product to be thermally processed ranges between about 0.005 to 7 mg/kg, preferably between about 0.1 to 5 mg/kg.

The coffee product to be thermally processed in the present invention further comprises a coffee extract, a stabilizer, a buffer, and water, preferably reduced oxygen content water.

The coffee can be derived from roasted arabica, robusta, or any combination of beans, ground and instant powder, and preferably, in the form of concentrated coffee extract solids. The concentration of the coffee extract solids is approximately 0.5-20%, more preferably 0.75-1.5%, and most preferably 0.95-1.1% by weight. These solids are dissolved in water to form the liquid product. The water is between approximately 80-95%, more preferably between approximately 85-92%, and most preferably between approximately 85-90% by weight of the total product.

The product further comprises buffers such as water-soluble potassium or sodium salts to adjust the pH. Any water-soluble buffers can be used. In addition to the potassium or sodium salts others such as potassium or sodium carbonate, potassium or sodium bicarbonate, dipotassium or disodium hydrogen phosphate, potassium or sodium dihydrogen phosphate, tripotassium or trisodium phosphate, potassium or sodium hydroxide, potassium or sodium succinate, potassium or sodium malate, potassium or sodium citrate, and mixtures thereof. Preferably, the buffer is selected from the group consisting of sodium or potassium bicarbonate, sodium or potassium carbonate, sodium or potassium citrate, and disodium or dipotassium hydrogen phosphate. The pH of the finished product is typically adjusted to between approximately 6 and 8 and preferably between 6.5 and 7.7. The potassium or sodium salt may be present in an amount of from about 0.1% to about 0.2% by weight of the total composition.

The product may also comprise a stabilizer. The stabilizer may contain conventional emulsifiers and gums and may also contain an optional milk derivative.

The product may generally comprise a sweetener or a combination of sweeteners. The sweetener may be any sweetener normally used in food processing, either natural or artificial, for example sugar alcohols and sugars such as sucrose, fructose, dextrose, maltose, lactose, high fructose corn syrup solids, erythritol, or mixtures thereof. The sweetener may be any suitable synthetic or natural sweetener, which may be a higher intensity sweetener and used in combination with the sugar or sugar alcohol. Examples of such sweeteners include, for example, sucralose, acesulfame potassium (acesulfame-K), and mixtures thereof. The sweetener may further comprise a mixture of natural or synthetic sweeteners, such as a sugar or sugar alcohol, used in combination with, for example, a high intensity sweetener. Any mixture or combination of natural or artificial sweeteners may be used. Other sweeteners normally used in food or beverage processing can be used if desired. Preferably the sweetener is selected from the group consisting of sucrose, dextrose, fructose, high fructose corn syrup, sucralose, and acesulfame-K. Typically, the sweetener will be present in an amount or amounts to provide a desired sweetness and a typical range is from about 0.5% to about 6% by weight of the total composition.

When a whitened coffee product is desired, the product may further comprise a whitener. Whiteners can include milk, cream, whey, yoghurt, ice cream, emulsifiers, maltodextrins, pectins, natural and synthetic gums and natural or chemically modified starches or mixtures thereof. Preferably, the whitener is milk, cream, non dairy creamer, soymilk, rice milk, and coconut milk.

The product may further comprise fortifying with vitamins. Any vitamin normally used in food processing can be used, such as but not limited to, ascorbic acid, biotin, folic acid, niacinamide and riboflavoid. The most preferred vitamin used in the product is ascorbic acid.

The product may further comprise a flavor component, either natural or artificial, as may be desired, such as almond, amaretto, anise, apple, brandy, caramel, cappuccino, cider, cinnamon, cherry, chocolate, chocolate mint, cocoa, coffee, creme de menthe, french vanilla, grape, hazelnut, irish cream, lemon, macadamia nut, mocha, orange, peach, peppermint, pistachio, strawberry, vanilla, wintergreen or mixtures thereof. Any other flavor normally used within the food or beverage processing industry may be utilized. Preferred flavors for the product include almond, amaretto, caramel, cappuccino, cider, cinnamon, chocolate, chocolate mint, cocoa, coffee, creme de menthe, hazelnut, mocha, peppermint, vanilla or mixtures thereof. The most preferred flavors include cocoa, vanilla, caramel and chocolate mint. Typically, the flavor or flavors are present in an amount of from about 0.1% to about 1% by weight of the total product.

The invention also relates to a method of delivering aroma and flavor to ready to drink coffee beverage comprising coffee extract, stabilizer, buffer and water, which comprises (1) adding a thioester precursor of the general structure R—S—CO—R′ to the beverage, wherein R is selected from the group of methyl, ethyl, propyl, isopropyl, prenyl, furfuryl, wherein R′ is selected from the group of H. methyl, ethyl, propyl, isopropyl and wherein the thioester precursor is present in the range of 0.005 to 7 mg/kg, such as 0.01 to 7 mg/kg, to provide improved flavor quality to said beverage for more than 4 months at ambient temperature and for more than 1 month at 60° C. storage; and (2) treating the resulting product with a thermal processing, such as retort, UHT, pasteurization, in the temperature range of 85° C. to 170° C. under an inert atmosphere. The effect of the thermal processing may be expressed by the F₀ value. F₀ is commonly used in the food industry to express the effect of thermal processing on microorganisms, and is the equivalent exposure time at 121° C. with regard to reduction of microorganisms and is expressed in minutes. F₀ is calculated as:

F₀=t*10^{(T-121)/10}

wherein t is treatment time in minutes and T is the actual temperature of treatment in degrees Celsius.

In one embodiment of the invention the thermal processing is performed at conditions to yield F₀ value of between 3 and 45.

In one embodiment of the invention, the thioester precursor is present in the range of 0.1 to 5 mg/kg. Preferably, the thioester precursor is furfurylthioacetate, methylthioacetate, prenylthioacetate or a mixture thereof.

In the method of the present invention, the inert atmosphere is preferably created by high purity nitrogen gas, argon, nitrous oxide, or carbon dioxide.

In another embodiment of the present invention, the temperature range used in the thermal processing to produce the flavor is 121.6° C. through 143° C. with F₀ values of 3 to 45.

In the present method, the coffee extract may be derived from roasted arabica, robusta, or any combination of beans, ground and instant powder, and the buffer may be selected from the group consisting of sodium or potassium bicarbonate, sodium or potassium carbonate, sodium or potassium citrate, and disodium or dipotassium hydrogen phosphate.

In one embodiment of the present method, the stabilizer may contain conventional emulsifiers and gums and may also contain an optional milk derivative.

In another embodiment of the present method, the ready to drink coffee beverage further comprises one or more sweeteners selected from the group consisting of sucrose, dextrose, fructose, high fructose corn syrup, sucralose, and acesulfame-K.

In yet another embodiment of the present method, the ready to drink coffee beverage further comprises one or more whiteners selected from the group consisting of milk, cream, non dairy creamer, soymilk, rice milk, and coconut milk.

The present invention also relates to a method of generating coffee aroma and flavor notes comprising adding FFT-Ac and initiating a chemical reaction at a desired rate in order to generate a desired level of FFT which serves as an aroma and flavor enhancer. The chemical reaction can be triggered by a thermal processing, such as retort, UHT, pasteurization, in temperature range of 85° C. to 170° C. under inert atmosphere.

### EXAMPLES

The following examples are merely illustrative of the present invention and they should not be considered as limiting the scope of the invention in any way, as these examples and other equivalents thereof will become apparent to those skilled in the art in light of the present disclosure and the accompanying claims.

### Example 1

### Black RTD Coffee

Arabica coffee is roasted, ground, extracted under inert atmosphere and stored in a canister with nitrogen protection.

Black RTD Coffee Final Product having the formula shown in Table 1 is prepared as follows:

(1) combining sugar and sodium bicarbonate buffer in a nitrogen protected atmosphere with mixing;

(2) adding nitrogen protected coffee extract from canister to above with mixing;

(3) adding flavor precursor (furfurylthioacetate, supplied at 1% in ethanol) with mixing;

(4) filling into steel cans with nitrogen gas headspace, seaming and retorting at F₀=35

The flavor precursor furfurylthioacetate is obtained from specialized Flavor Houses.

TABLE 1
Formula for Black RTD Coffee Final
Product with Added Flavor Precursor

| Ingredient | Kgs/15 Kg |
|---|---|
| Sucrose | 0.45000 |
| Coffee Extract | 8.62800 |
| Buffer | 0.02250 |
| Flavor Precursor | 0.00006 |
| Ethanol | 0.00594 |
| Water | 5.89310 |
| TOTAL | 15.00000 |

A control Black RTD Coffee Final Product is prepared by adding ethanol without flavor precursor (see Formula in Table 2).

TABLE 2
Formula for Control Black RTD Coffee Final Product

| Ingredient | Kgs/15 Kg |
|---|---|
| Sucrose | 0.450 |
| Coffee Extract | 8.628 |
| Buffer | 0.023 |
| Ethanol | 0.006 |
| Water | 5.893 |
| TOTAL | 15.000 |

As a further comparison, another Black RTD Coffee Final Product with added flavor (furfurylthiol, supplied at 1% in ethanol) instead of flavor precursor is also prepared (see Formula in Table 3).

TABLE 3
Formula for Black RTD Coffee Final Product with Added Flavor

| Ingredient | Kgs/15 Kg |
|---|---|
| Sucrose | 0.450000 |
| Coffee Extract | 8.628000 |
| Buffer | 0.022500 |
| Flavor (Furfurylthiol) | 0.000044 |
| Ethanol | 0.004356 |
| Water | 5.895100 |
| TOTAL | 15.000000 |

The Black RTD Coffee Final Products and controls are stored at −40° C., 38° C. and 60° C.

### Example 2

### Milk Based RTD Coffee

Arabica coffee extract is prepared as described in Example 1.

(a) Preparation of Milk Base Solution Having the Formula Shown in Table 4:

(1) predissolving stabilizer in water using high shear mixing;

(2) adding the predissolved stabilizer to heated milk and cream with mixing;

(3) homogenizing; and

(4) storing in canister under nitrogen gas protection.

TABLE 4
Formula for Milk base

| Ingredient | Kgs/100 Kg |
|---|---|
| Heavy Cream | 3.758 |
| Fluid Milk(Whole) | 79.253 |
| Stabilizer | 0.989 |
| Water | 16.000 |
| Total | 100.000 |

(b) Preparation of Milk RTD Coffee Final Product Having the Formula Shown in Table 5:

(1) Combining sugar and buffer in nitrogen protected atmosphere with mixing;

(2) adding nitrogen protected coffee extract from canister to above with mixing;

(3) adding milk base from canister with mixing;

(4) adding flavor precursor (furfurylthioacetate, supplied at 1% in ethanol) or flavor (furfurylthiol, supplied at 1% in ethanol) with mixing; and

(5) filling into steel cans with nitrogen gas headspace, seaming and retorting at F₀=35.

TABLE 5
Formula for Milk RTD Coffee Final product with added Precursor

| Ingredient | Kgs/15 Kg |
|---|---|
| Sucrose | 0.78000 |
| Coffee Extract | 11.25000 |
| Milk Base | 2.63100 |
| Buffer | 0.02250 |
| Flavor Precursor (FFT-Ac) | 0.00006 |
| Ethanol | 0.00594 |
| Water | 0.31050 |
| TOTAL | 15.00000 |

TABLE 6
Formula for Milk RTD Coffee Final product with added Flavor

| Ingredient | Kgs/15 Kg |
|---|---|
| Sucrose | 0.78000 |
| Coffee Extract | 11.25000 |
| Milk Base | 2.63100 |
| Buffer | 0.02250 |
| Flavor (furfurylthiol) | 0.00006 |
| Ethanol | 0.00594 |
| Water | 0.31050 |
| TOTAL | 15.00000 |

Control Milk RTD Coffee Final Product is prepared by omitting flavor precursor or flavor (see Formula in Table 7).

TABLE 7
Formula for Control Milk RTD Coffee Final product

| Ingredient | Kgs/15 Kg |
|---|---|
| Sucrose | 0.7800 |
| Coffee Extract | 11.2500 |
| Milk Base | 2.6310 |
| Buffer | 0.0225 |
| Ethanol | 0.0060 |
| Water | 0.3105 |
| TOTAL | 15.0000 |

Results of the sensory analysis and chemical analysis are as follows:

### Sensory Analysis

12 panelists who are experienced in assessing taste differences in coffee products evaluated and compared the previous samples. Each stored sample was compared to the frozen reference (−40° C. furfurylthioacetate sample) and scored on a scale of −5 to +5 with the frozen reference being 0.

Results are as follows for the black products:

| | Acidic/Sour | Roasty |
|---|---|---|
| | Flavor | Flavor |
| REF = 2237.02 w FFT Acetate Black 4 | 0 | 0 |
| wks −40 C. | | |
| Sample 2 = 2237.01 Control Black 4 wks 60 C. | 0.67 | −0.67 |
| Sample 3 = 2237.02 w FFT Acetate Black | 0.36 | −0.61 |
| 4 wks 60 C. | | |
| Sample 4 = 2237.03 w Furfurylthiol Black | 0.59 | −1.1 |
| 4 wks 60 C. | | |

The Black FFT Acetate product stored 4 wks at 60° C. had more roasty flavor and less acidic/sour flavor.

Results are as follows for the milk products:

| | Coffee | Roasty | Dairy Sour | Roasty | Coffee |
|---|---|---|---|---|---|
| | Aroma | Aroma | Flavor | Flavor | Flavor |
| REF = 2232.03 w FFT Acetate | 0 | 0 | 0 | 0 | 0 |
| Milk 4 wks −40 C. | | | | | |
| Sample 2 = 2232.02 Control Milk | −0.40 | −0.48 | 0.13 | −.061 | −0.58 |
| 4 wks 60 C. | | | | | |
| Sample 3 = 2232.03 w FFT | 0.09 | −0.09 | 0.11 | −0.21 | −0.18 |
| Acetate Milk 4 wks 60 C. | | | | | |
| Sample 4 = 2232.04 w | −0.71 | −1.23 | 0.65 | −1.04 | −1.04 |
| Furfurylthiol Milk 4 wks 60 C. | | | | | |

The Milk FFT Acetate product stored 4 wks at 60° C. had more coffee aroma, more roasty aroma, more roasty flavor, more coffee flavor and was lowest in dairy sour flavor.

### Chemical Analysis

A standard laboratory method was used to evaluate the previous samples throughout storage for pH.

pH results are as follows for the black products:

| | Before | After | 2 wk | 2 wk | 2 wk | 4 wk | 4 wk | 4 wk |
|---|---|---|---|---|---|---|---|---|
| | retort | retort | (−40 C.) | 38 C. | 60 C. | (−40 C.) | 38 C. | 60 C. |
| 2237.01 Control | 6.82 | 6.12 | | 6.22 | 6.13 | | 6.20 | 6.10 |
| Black | | | | | | | | |
| 2237.02 w FFT | 6.80 | 6.11 | 6.25 | 6.23 | 6.16 | 6.32 | 6.41 | 6.28 |
| Acetate Black | | | | | | | | |
| 2237.03 w | 6.81 | 6.13 | | 6.24 | 6.18 | | 6.20 | 6.08 |
| Furfurylthiol Black | | | | | | | | |

The Black FFT Acetate product had a pH of 0.18 and 0.20 units higher after 4 wks storage at 60° C. compared to the Control and Furfurylthiol products, respectively. Acidity formation in RTD coffee is a well known problem and affects the sensory quality of the product during storage. The addition of FFT Acetate offers a way to prevent acid formation and improve the RTD coffee flavor.

pH results are as follows for the milk products:

| | | | 2 wk | 2 wk | 2 wk | 4 wk | 4 wk | |
|---|---|---|---|---|---|---|---|---|
| | Before retort | After retort | (−40 C.) | 38 C. | 60 C. | (−40 C.) | 38 C. | 4 wk 60 C. |
| 2232.02 Control | 6.85 | 6.31 | | 6.36 | 6.32 | | 6.25 | 6.10 |
| Milk | | | | | | | | |
| 2232.03 w FFT | 6.85 | 6.33 | 6.57 | 6.56 | 6.50 | 6.59 | 6.56 | 6.45 |
| Acetate Milk | | | | | | | | |
| 2232.04 w | 6.87 | 6.35 | | 6.44 | 6.36 | | 6.44 | 6.32 |
| Furfurylthiol Milk | | | | | | | | |

Surprisingly, the Milk FFT Acetate product maintained a higher pH throughout storage. It was 0.35 and 0.13 units higher than the Control and Furfurylthiol products, respectively, after 4 wks storage at 60° C. This higher pH value would explain why the FFT Acetate stored product had less sour dairy flavor compared to the Control and Furfurylthiol products. We have observed less sour dairy flavor formation during storage using this same Milk FFT Acetate formula when tasted side by side with an untreated Control in a previous study that was stored at 38° C. for 6 months.

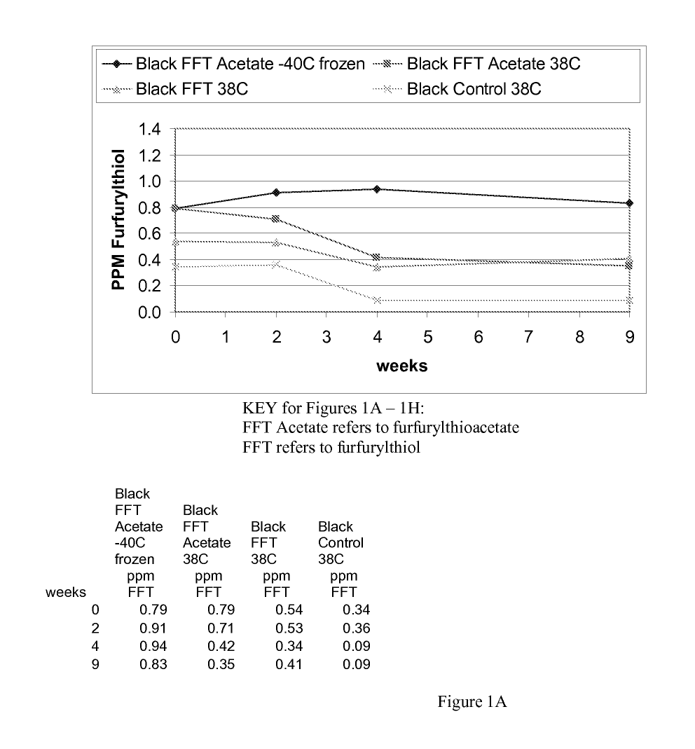

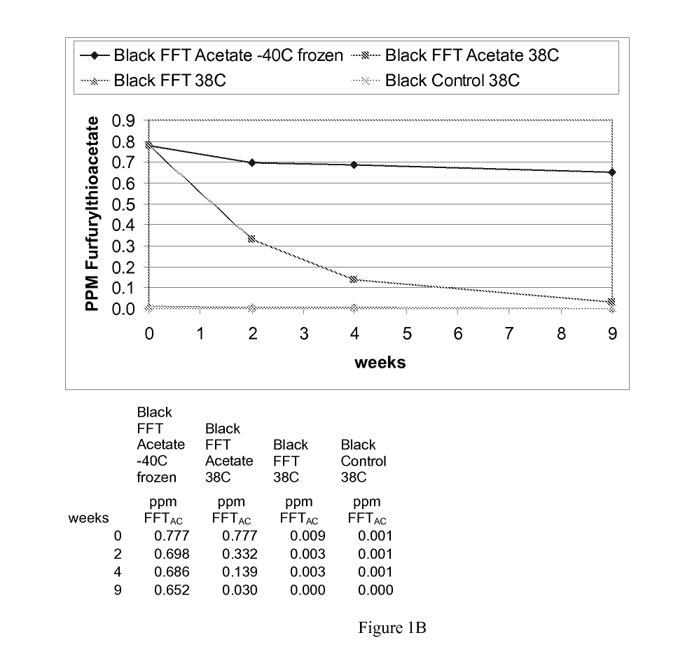

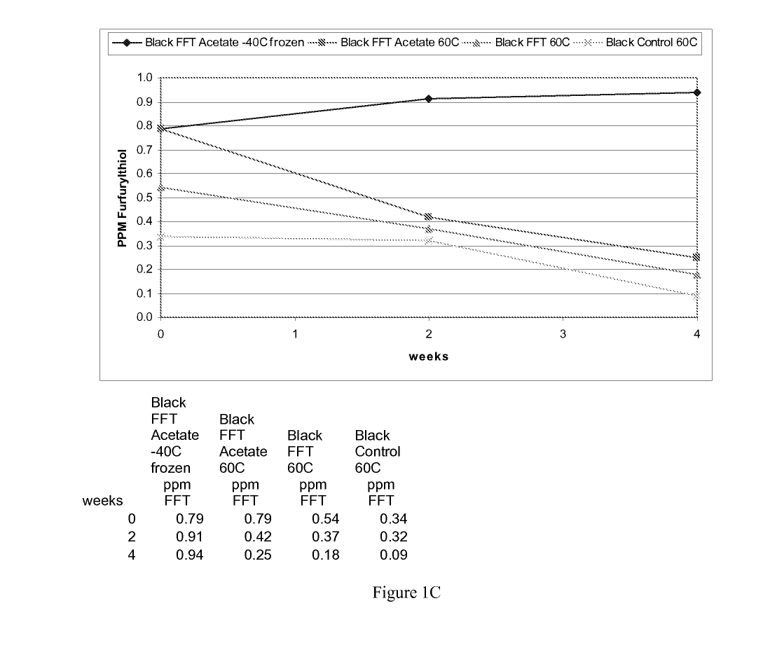

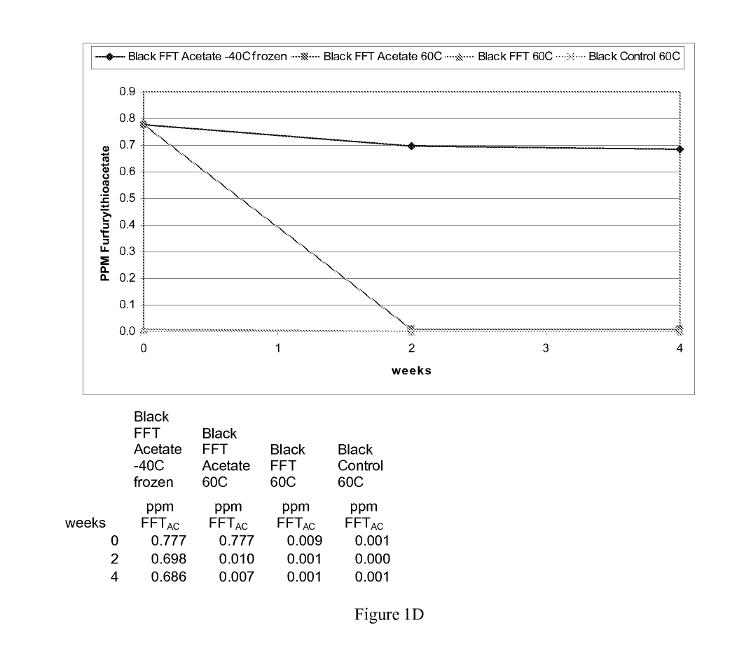

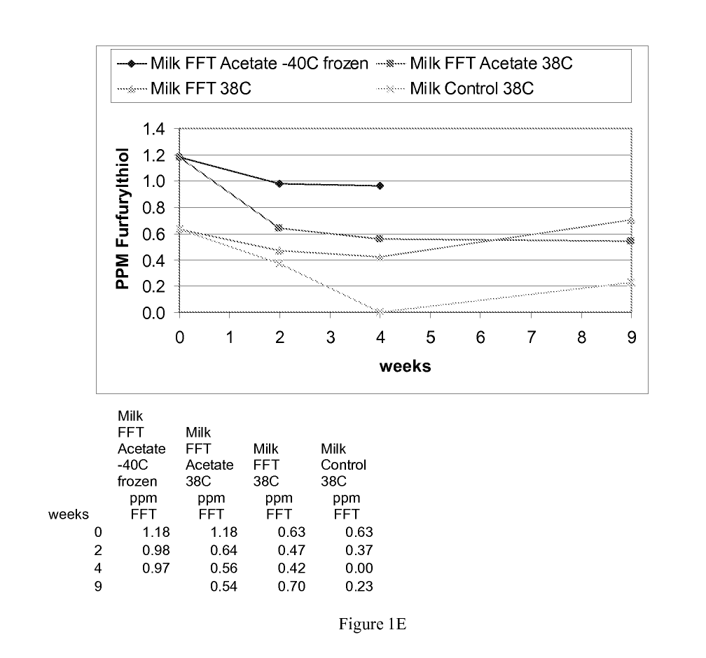

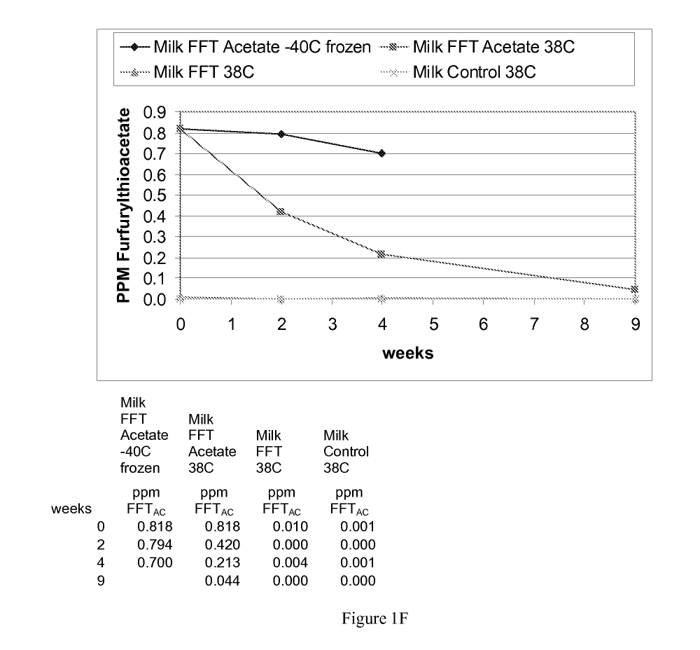

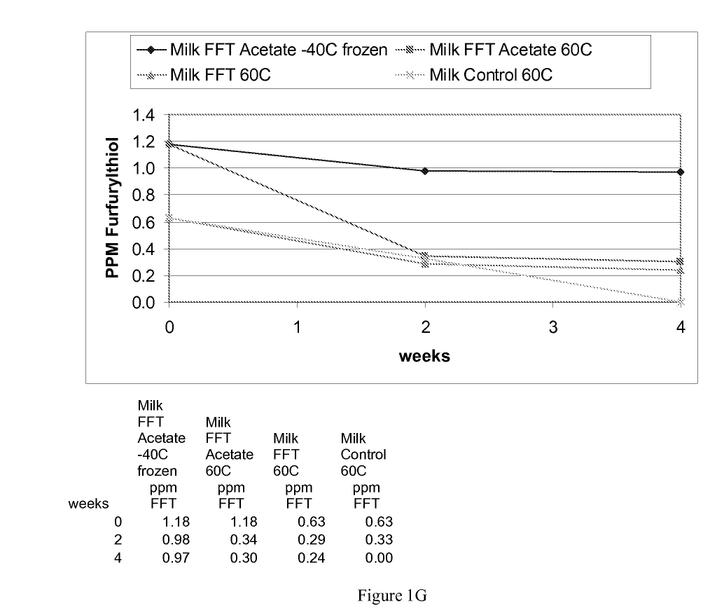

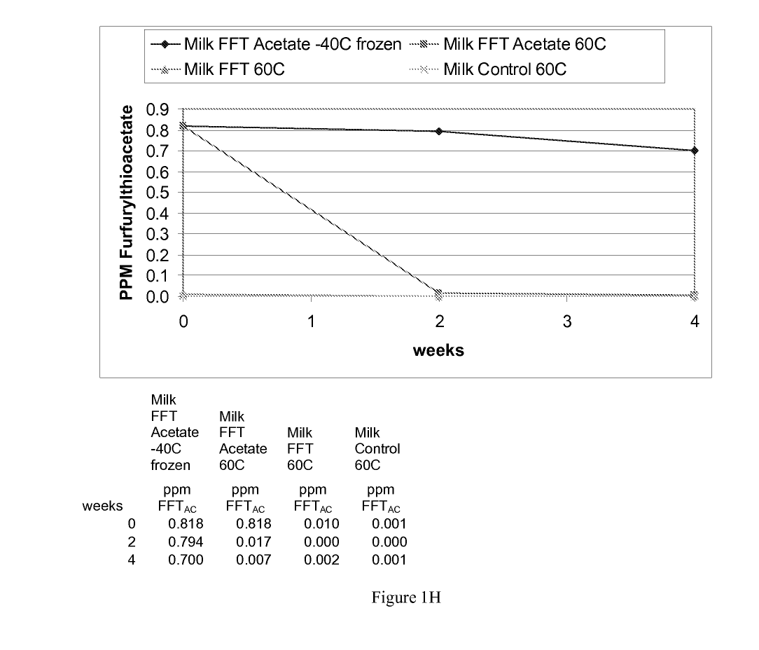

Two chemical compounds were monitored in these products during storage using a calibrated Isotope Dilution Headspace SPME method and labeled standards. These were furfurylthiol and furfurylthioacetate (see FIGS. 1A-H).

1. A thermally processed and stored ready to drink liquid coffee product comprising a coffee, a stabilizer, a buffer, water and a thioester flavor precursor in an amount sufficient to provide improved flavor quality to the product after thermal processing and storage of the liquid product for more than 4 months at ambient temperature and for more than 1 month at 60° C. storage.

2. The product of claim 1, wherein the thioester flavor precursor is of the structure R—S—CO—R′, wherein R is selected from the group consisting of methyl, ethyl, propyl, isopropyl, prenyl, and furfuryl, and R′ is selected from the group consisting of H, methyl, ethyl, propyl, and isopropyl.

3. The product of claim 1, wherein the concentration of the thioester flavor precursor is between about 0.005 to 7 mg/kg.

4. The product of claim 1, wherein the thioester flavor precursor is selected from the group consisting of furfuryl-thioacetate, methylthioacetate, prenylthioacetate and mixtures thereof, and the concentration of the thioester flavor precursor is between about 0.1 to 5 mg/kg.

5. The product of claim 1, wherein the coffee is derived from roasted arabica, robusta, or any combination of beans, ground and instant powder.

6. The product of claim 1, wherein the buffer is selected from the group consisting of sodium or potassium bicarbonate, sodium or potassium carbonate, sodium or potassium citrate, and disodium or dipotassium hydrogen phosphate.

7. The method of claim 1, wherein the stabilizer comprises conventional emulsifiers and gums product.

8. The product of claim 1 comprising one or more sweeteners selected from the group consisting of sucrose, dextrose, fructose, high fructose corn syrup, sucralose, and acesulfame-K.

9. The product of claim 1, comprising one or more whiteners selected from the group consisting of milk, cream, non dairy creamer, soymilk, rice milk, and coconut milk.

10. A method of delivering aroma and flavor to a ready to drink coffee beverage comprising coffee, stabilizer, buffer and water, comprising: adding a thioester precursor of the structure of R—S—CO—R′ to the beverage, wherein R is selected from the group consisting of methyl, ethyl, propyl, isopropyl, prenyl, furfuryl, and R′ is selected from the group consisting of H, methyl, ethyl, propyl, isopropyl, and the thioester precursor is present in the range of 0.005 to 7 mg/kg to provide improved flavor quality to the beverage for more than 4 months at ambient temperature and for more than 1 month at 60° C. storage; and treating the resulting product with a thermal processing in temperature range of 85° C. to 170° C. under inert atmosphere.

11. The method of claim 10, wherein the thioester precursor is present in an amount of 0.1 to 5 mg/kg.

12. The method of claim 10, wherein the thioester precursor is selected from the group consisting of furfurylthioacetate, methylthioacetate, prenylthioacetate and a mixture thereof.

13. The method of claim 10, wherein the inert atmosphere is created by a gas selected from the group consisting of high purity nitrogen gas, argon, nitrous oxide, and carbon dioxide.

14. The method of claim 10, wherein the temperature range to produce the flavor is 121.6° C. to 143° C. with F₀ values of 3 to 45.

15. The method of claim 10, wherein the coffee is derived from roasted arabica, robusta, or any combination of beans, ground or instant powder or a blend thereof.

16. The method of claim 10, wherein the buffer is selected from the group consisting of sodium or potassium bicarbonate, sodium or potassium carbonate, sodium or potassium citrate, and disodium or dipotassium hydrogen phosphate.

17. The method of claim 10, wherein the stabilizer comprises conventional emulsifiers and gums.

18. The method of claim 10, wherein the ready to drink coffee beverage comprises one or more sweeteners selected from the group consisting of sucrose, dextrose, fructose, high fructose corn syrup, sucralose, and acesulfame-K.

19. The method of claim 10, wherein the ready to drink coffee beverage comprises one or more whiteners selected from the group consisting of milk, cream, non dairy creamer, soymilk, rice milk, and coconut milk.

20. A method of generating coffee aroma and flavor notes comprising adding to a coffee furfurylthioacetate (FFT-Ac) and initiating a chemical reaction at a desired rate in order to generate a desired level of FFT which serves as an aroma and flavor enhancer, wherein the chemical reaction is triggered by a thermal processing in temperature range of 85° C. to 170° C. under inert atmosphere.

21. A ready to drink liquid beverage comprising an ingredient selected from the group consisting of coffee, cocoa, and chocolate and comprising a thioester flavor precursor in an amount sufficient to provide improved flavor quality to the product after heat treatment followed by storage at various temperatures for more than 4 months.

22. An ingredient to be heat processed to produce a fresher flavor with improved stability over time by means of a thioester flavor precursor to be incorporated into a beverage.

23. The product of claim 1, wherein the stabilizer comprises a milk derivative.

24. The method of claim 10, wherein the thermal processing is a process selected from the group consisting of retort, UHT, and pasteurization.

25. The method of claim 10, wherein the stabilizer comprises milk derivative.

26. The method of claim 20, wherein the thermal processing is a process selected from the group consisting of retort, UHT, and pasteurization.
